(19) United States
(12) Patent Application Publication
(10) Pub. No.: US 2014/0372682 A1
(43) Pub. Date: Dec. 18, 2014

(54) NONVOLATILE MEMORY BANK GROUPS

(71) Applicant: Melvin K. Benedict, Magnolia, TX (US)

(72) Inventor: Melvin K. Benedict, Magnolia, TX (US)

(21) Appl. No.: 14/368,573

(22) PCT Filed: Mar. 27, 2012
(86) PCT No.: PCT/US2012/030772

§ 371 Date: Jun. 25, 2014

(51) Int. Cl. G06F 12/02

(52) U.S. Cl. CPC G06F 12/0246; G06F 2212/7201
USPC 711/103

(57) ABSTRACT

A nonvolatile memory (10) is partitioned into bank groups (24) based upon a write-to-read latency of the nonvolatile memory (10).

### BACKGROUND

Nonvolatile memory is sometimes employed to address high density demands for larger storage capacity memory devices. However, many nonvolatile memory technologies have high write latencies that may consume large amounts of time for write operations and that may demand significant buffering or complex staging elements.

### BRIEF DESCRIPTION OF THE DRAWINGS

FIG. 1 is a schematic illustration of an example nonvolatile memory device having a bank group architecture.

FIG. 2 is a flow diagram of an example method for forming the bank group architecture on the nonvolatile memory device of FIG. 1.

FIG. 3 is a schematic illustration of an example memory system including the nonvolatile memory device of FIG. 1.

FIG. 4 is a flow diagram of an example method for writing to the nonvolatile memory device of FIG. 1.

FIG. 5 is a time diagram illustrating writing to different bank groups of the nonvolatile memory device of FIG. 3 according to the method of FIG. 4.

FIG. 6 is a time diagram illustrating overlapping of write operations by read operations for the different bank groups of the nonvolatile memory device of FIG. 3 according to the method of FIG. 4.

FIG. 7 is a flow diagram of another example method for writing to the nonvolatile memory device of FIG. 1.

### DETAILED DESCRIPTION OF THE EXAMPLE EMBODIMENTS

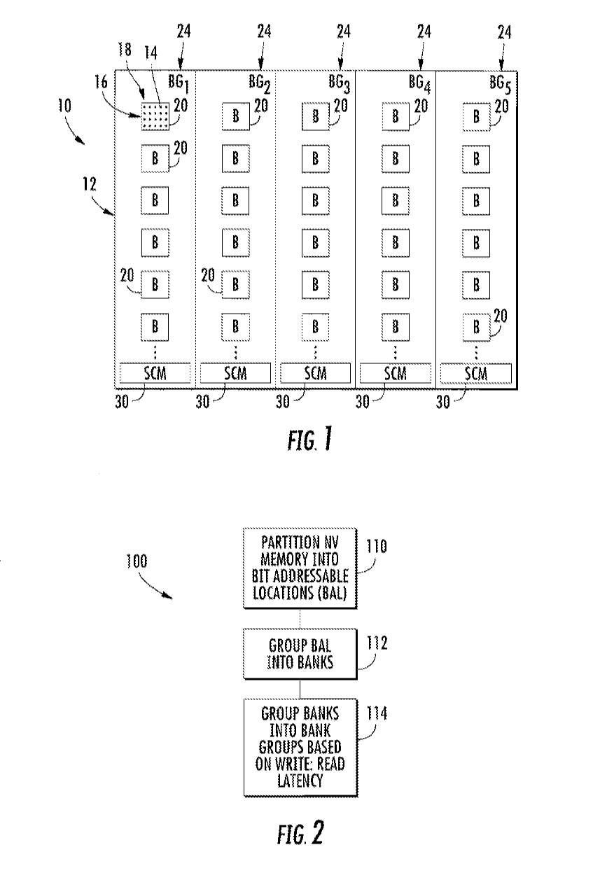

FIG. 1 schematically illustrates an example non-volatile memory device 10. Memory device 10 comprises a nonvolatile memory or storage device having memory elements that retain stored information even when not powered. In one implementation, nonvolatile memory 10 comprises a phase change memory elements. In another implementation, nonvolatile memory comprises a non-charge based memory elements such as spin torque transfer memory elements, resistive memory elements (memristor technology) and the like. Examples of non-volatile memory include flash memory, ferroelectric random access memory (F-RAM) electronic voting machines (EVMs), magnetic computer storage devices, optical disks and the like. One implementation, the memory elements of nonvolatile memory device 10 have a write-to-read latency of at least 4:1. In other words, it takes four times as long to complete a write operation as it does to access or read the same memory unit to initiate a write operation. As will be described hereafter, memory device 10 has a bank group architecture 12 based upon a write-to-read latencies of the particular non-volatile memory storage elements to conceal such write-to-read latencies to reduce buffering demands and to consume less time during such writing operations.

FIG. 2 is a flow diagram illustrating an example method 100 for providing nonvolatile memory device 10 with the aforementioned bank group architecture 12. As indicated by step 110, the non-volatile memory elements or memory materials of nonvolatile memory 10 are partitioned into bit addressable locations (BAL) (schematically indicated by reference numeral 14 in FIG. 1). Such bit addressable locations 14 are generally arranged in rows 16 (also known as pages) and columns 18.

As indicated by step 112, the bit addressable locations are grouped into individual banks 20 of bit addressable locations 14. Banks 20 collectively form or provide the addressable space for memory device 10. Each bank 20 comprises an addressable unit or set of locations in the memory space. In one implementation, each bank 20 comprises between 32 Mb and 32 Gb bits. In other implementations, each bank 20 may have other data storage sizes.

As indicated by step 114, banks 20 are then grouped into bank groups 24. In addition to the banks allocator assigned thereto, each bank group also includes a dedicated state control machine 30. Each state control machine 30 comprises electronic circuitry configured to control the sequencing of reading and writing operations in the banks of the assigned bank group. For example, each state control machine may control erasing of prior data and the rewriting of new data to memory elements of a bank.

The partitioning or grouping of banks 20 into bank groups 24 is based upon write-to-read latency of the particular non-volatile memory elements or materials. The total addressable space in device 12 is allocated amongst a number of bank groups such that a collective time to read (time to access or begin writing) a single bank in each and all of the other bank groups is at least a majority of a time to write to an individual bank of an individual bank group. In other words, if there are five total bank groups, the collective time to read or access four banks (reading a bank in each of banks 2-5) is at least a majority of the time to complete a write operation in an individual bank (bank 1). As a result, while one bank of one bank group is being written to, banks in other bank groups may be concurrently accessed such that writing may begin in the other bank groups while the initial bank group is being written upon. Consequently, at least a majority of the large write-to-read latencies that may be found in nonvolatile memory may be concealed through this multiplexing of different bank groups to reduce overall write operation time consumption. In other words, at least a majority of the time that would otherwise be spent idling waiting for as write operation in a bank in a bank group to be completed before initiating a write operation in another bank of the same bank group is not wasted, but is utilized to begin writing. of data in other bank groups. For purposes of this disclosure, the term “majority” means greater than 50%.

In one implementation, the partitioning of the addressable space or the partitioning of the banks into bank groups is performed in as manner such that the addressable space is partitioned into a number of bank groups exceeding a write-to-read latency of the individual banks of the non-volatile memory. For example, if the write-to-read latency of as particular nonvolatile memory is 4 to 1 (it takes four times as long to complete a write as it does to read or access memory unit, such as a bank), the nonvolatile memory is partitioned into at least five bank groups of equal size, 5 being greater than 4. If the write-to-read latency of the particular nonvolatile memory is 5.5 to 1, the nonvolatile memory is partitioned into at least 6 bank groups of equal size. In such an implementation, the number and size of the bank groups are defined such that the time to read a single bank in all of the bank groups is greater than a time to write to an individual bank of an individual bank group. Consequently, the entire, otherwise idle, time spent waiting for a write operation to be completed in a bank of a bank group before initiating writing operation of another bank of the same bank group is not wasted, but is fully utilized to initiate writing (completing the initial access or read operations) in banks of other bank groups.

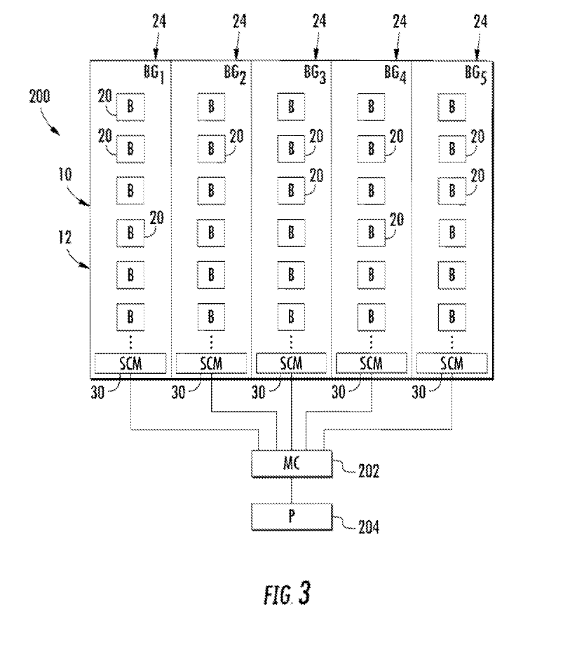

FIG. 3 schematically illustrates an example memory system 200. Memory system 200 comprises memory device 10 with bank group architecture 12 and additionally includes memory controller 202 and processor 204. Memory controller 202 interfaces between a processor 204 and memory device 200. In some implementations, memory controller 202 interfaces between a processor in an intermediate buffer or register on a memory module which includes one or more memory devices 10. Memory controller 202 directs the reading and writing of data to memory device 10. In one implementation, memory controller 202 may be provided as part of a chipset. In other implementations, memory controller 202 may be provided as part of processor 204 or may have other forms.

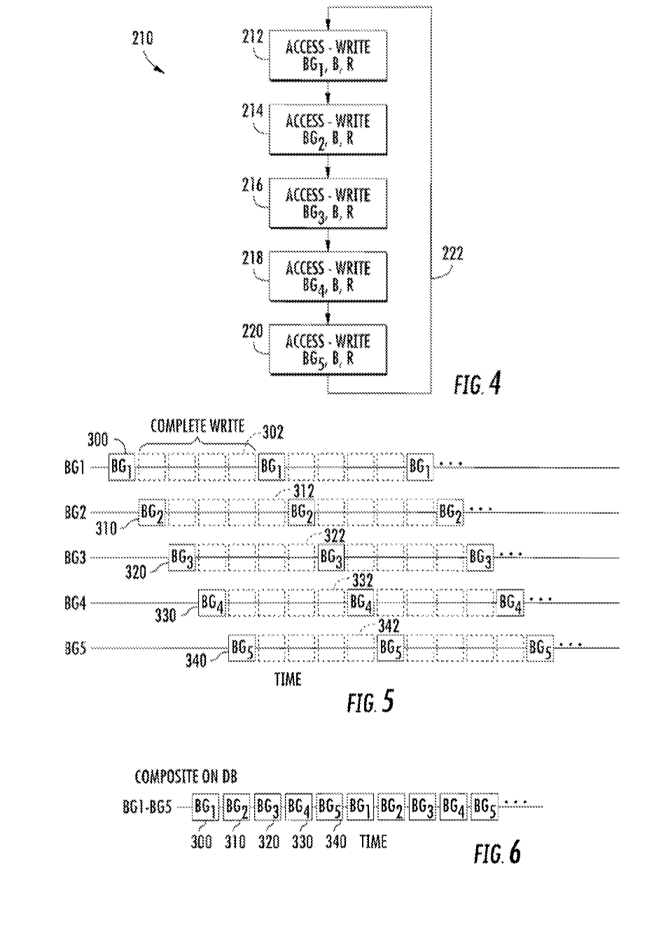

Memory controller 202 receives activation commands (commands to initiate writing on one or more banks of memory device 10) from processor 204 and directs appropriate read and write signals to state control machines 30 so as to carry out the example method 210 shown in FIG. 4. In particular, as indicated by step 212, memory controller 202 transmits activate signals to initiate a write operation on a row (R) of a bank (B) of bank group 1 (BG₁). In response to such signals, state control machine 30 of bank group 1 accesses the relevant bank of bank group 1 (i.e. reads the relevant bank of bank group 1) and then begins a write operation.

As indicated by step 214 in FIG. 4, once the row of the bank of bank group 1 has been accessed (at the end of the time block 300) such that writing to the row of the bank of bank group 1 may begin, memory controller 202 initiates a subsequent write operation to a different bank group. As indicated by steps 214-220 in by FIG. 4, memory controller 202 initiates a write operation to each of the other bank groups BG. In the example illustrated, memory controller 202 initiates write operations in each of bank groups BG₂-BG₅. Once a writing operation has been started (a read or access operation has been completed to allow writing to begin) on each of the other bank groups, memory controller 202 returns to the first bank group, bank group 1 (BG₁) to initiate a subsequent write operation to another row of the bank or a different bank of bank group 1. Because memory device 10 (shown in 3) has a partitioned into a number of bank groups greater than the read-to-write latency of the particular nonvolatile memory medium, when memory controller 202 returns to the first initial bank group, the prior writing to the first or initial bank group is complete. As a result, memory controller 202 does not have to wait for such writing to be completed before beginning a subsequent write action within the same bank group. Thus, the prolonged writing latency associated with nonvolatile memory 10 is concealed (the otherwise wasted waiting time is utilized) to reduce overall writing time for nonvolatile memory device 10.

FIG. 5 diagrammatically illustrates operation of memory system 200 pursuant to method 210. In the example illustrated, the non-volatile memory has a write-to-read latency ratio of 4:1 with the device 10 partitioned into five bank groups. The reading of the row of the bank of the bank group 1 is represented in the graph of FIG. 5 with time block 300. The subsequent time required to complete the writing to the row of the bank of bank group 1 is indicated by the four time blocks 302 illustrated with broken lines. Pursuant to step 212, memory controller 202 begins writing on bank group 1 as represented by time block 300, wherein the continued writing following the read operation as indicated by time blocks 302.

Pursuant to step 214 in FIG. 4 and as represented by time block 310 in FIG. 5, once the row and bank of bank group 1 has been read or accessed such that writing may begin, memory controller 302 initiates writing to bank group 2, wherein the continued writing following the read operation is indicated by time blocks 312.

Pursuant to step 216 in FIG. 4 and as represented by time block 320 in FIG. 5 once the row and bank of bank group 2 has been read or accessed such that writing may begin, memory controller 202 initiates writing to bank group 3, wherein, the continued writing following the read operation is indicated by time blocks 322.

Pursuant to step 218 in FIG. 4 and as represented by time block 330 in FIG. 5, once the row and bank of bank group 3 has been read or accessed such that writing may begin, memory controller 202 initiates writing to bank group 4, wherein the continued writing following the read operation is indicated by time blocks 332.

Pursuant to step 220 in FIG. 4 and as represented by time block 340 in FIG. 5, once the row and bank of bank group 4 has been read or accessed such that writing may begin, memory controller 202 initiates writing to bank group 4, wherein the continued writing following the read operation is indicated by time blocks 332.

As indicated by arrow 222 in FIG. 4, once the row and bank of banker 5 hasn't read or accessed such that writing may begin, memory controller 202 returns to the first bank group, bank group 1 in the example, and initiates a second writing operation in bank group 1. For example, memory controller 202 may initiate a second writing operation at a different row of the previous bank of bank group 1 or a new bank of bank group 1. Once reading or access to bank 1 has been completed and writing has begun, memory controller 202 proceeds to the next bank group, bank group 2, and initiates a second or subsequent writing operation in bank group 2 and so on. This pattern or process is repeated in a continuous looped or circular fashion for each of the bank groups.

FIG. 6 is a composite time diagram of the access or reading operations on the data bus between memory controller 202 in memory device 10 during the operation of method 210. As shown by FIG. 6, all or substantially all of the write time, the time utilized to write to the bank groups after the individual banks have been initially read or accessed for writing (indicated by the broken line time boxes in 5) is overlapped with read activities on the various bank groups (read activities indicated by time boxes 300, 310, 320 330, and 340 in FIG. 5). As result, time is not spent waiting for a write operation to be completed before initiating another write operation in the same bank group. Time and the use of the data bus between memory controller 202 and memory device 10 is fully or substantially fully utilized to conceal the large write latencies often associated with nonvolatile memory.

It should be emphasized that although the example depicted in FIGS. 3-6 illustrates nonvolatile memory device 10 and its use, wherein memory device 10 has a write-to-read latency of 4:1 and has been partitioned into five bank groups, in other implementations, nonvolatile memory device 10 may have greater write-to-read latencies and may maybe partitioned into different numbers of bank groups. As noted above, in some implementations, nonvolatile memory device 10 may be partitioned into bank groups such that not all of the write time is overlapped or utilized to read other bank groups, but wherein at least a majority of the write time is overlapped or utilized to read other bank groups.

Although FIGS. 4-6 illustrate an method wherein a write operation in a first bank of each and every one of the bank groups of a memory device 12 is initiated before initiating another write operation in a second bank of the first bank group that was written upon, in other implementations, the first bank group that was written upon may be returned to for initiating a write action in another bank on the first bank group prior to the write action being initiated in each of every other bank group. For example, while a bank in a first bank group is being written to, writing actions to an individual bank in each of other bank groups may be initiated until the write action in the bank of the first bank group is completed, wherein once the write action in the bank of the first bank is completed, writing to another bank of the first bank group is automatically initiated despite a writing action not being initiated on each and every one of the other bank groups.

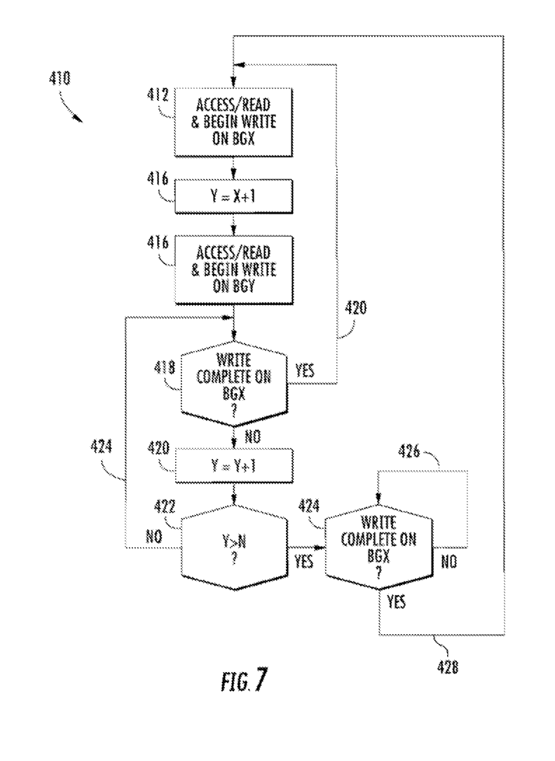

FIG. 7 is a flow diagram illustrating an example method 410 for carrying out read-write operations a nonvolatile memory partitioned into different bank groups, wherein the continuous loop 222 in the method of FIG. 4 is not triggered in response to each and every one of the other bank groups being read, but is instead triggered in response to a determination that the write operation on the initial bank group in the series of bank groups has been completed. Once the write action in the bank of the first bank is completed, writing to another bank of the first bank group is automatically initiated despite a writing action not being initiated on each and every one of the other bank groups. As indicated by step 412 in FIG. 7, memory controller 202 transmits signals initiating an axis or read in the beginning of a write operation on a first or initial bank group BGx. As indicated by step 414 and 416, once the access/read operation has been completed on the initial group BGx, memory controller 202 initiates an axis/read operation to begin a writing operation on one of the other bank groups BGy.

As indicated by step 418, once the access/read operation has been completed on the other bank group BGy, a determinist made as to whether the write operation on the initial bank group BGx has been completed. As indicated by arrow 420, if the write operation has completed on the initial bank group BGx, memory controller 202 returns to the initial bank group BGx to initiate a second write operation in the bank group BGx. This may occur before a write operation has been initiated (a read operation has been completed) on all of the other bank groups in the particular memory device.

As indicated by steps 420, 422 and arrow 424, if the write operation is not yet completed on the initial bank group BGx and there remains other bank groups on the memory device (which are not currently undergoing a write operation), memory controller 202 initiates an axis/read operation on yet another different bank group BGy on the memory device. This cycle continues until either the write operation on initial bank group BGx has been completed as determined in step 418 or until the bank groups in the memory device have been exhausted (y>n, where n is equal to total number of bank groups on the memory device) such that there are no more bank groups for which writing may be initiated as determined in step 422.

As indicated by step 424, once a read operation has been completed on each and every other of the bank groups in the memory device, memory controller 202 determines whether the write operation on the initial bank group BGx has been completed. As indicated by arrow 426, if the write operation has not yet been completed, memory controller 202 waits for the completion of the write operation on initial bank group BGx. Even though such a circumstance involves a wait time, at least a majority the wait time is consumed or utilized for initiating write operations on the other bank groups. As indicated by arrow 428, once a write operation on initial bank group BGx has been completed, memory 202 initiates a write operation (and access/read operation followed by initiation of writing) once again on the initial bank group BGx (on a different row of the same bank or a different bank).

Although the Figures illustrate memory device 10 as having an example write-to-read latency of 4:1, wherein the addressable memory space of memory device 10 is partitioned or grouped into a minimal number of bank groups that exceeds the write-to-read latency (five bank groups in the example), in other implementations, a memory device 10 may be partitioned into a number of bank groups exceeding the write-to-read latency by more than one bank group. In such an implementation, memory controller 202 may return to a bank group for initiating it subsequent writing action to the bank group either after a write operation has begun (a read operation baa been completed) on each of the other bank groups or automatically in response to the write operation being completed on the initial bank group.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a nonvolatile memory (10) partitioned into bits (14) grouped in banks (20), the banks (20) partitioned into a number of bank groups (24) exceeding a write-to-read latency of the non-volatile memory (10); and
a dedicated state control machine (30) coupled to each of the bank groups (24), wherein each dedicated state control machine (30) is to control read and write operation in the banks (20) of the bank group (20).

2. The apparatus of claim 1, wherein the nonvolatile memory (10) has a write-to-read latency of at least 4:1.

3. The apparatus of claim 1, wherein a time to read a single bank (20) in all of the bank groups (24) is at least a majority of a time to write to an individual bank (20) of an individual bank group (24)

4. The apparatus of claim 1, wherein a time to read a single bank (20) in all of the bank groups (24) is greater than a time to write to an individual bank (20) of an individual bank group (24).

5. The apparatus of claim 1, wherein a time to read one of the banks (20) is less than a time to write to an individual bank (20).

6. The apparatus of claim 1, wherein a time to read one of the banks (20) is less than the time to write to individual banks (20).

7. The apparatus of claim 1, wherein the nonvolatile memory (10) comprises a phase change memory.

8. The apparatus of claim 1, wherein the nonvolatile memory (10) comprises non-charge based memory elements.

9. The apparatus of claim 1 further comprising a memory controller (202) configured to write to a first bank (20) of a first one of the bank groups (24) while concurrently reading a bank (20) of each of a plurality of bank groups (24).

10. A method comprising:
partitioning a nonvolatile memory (10) into bit addressable locations grouped in the banks (10);
grouping the banks (20) into bank groups (24) based on a write-to-read latency of the nonvolatile memory (10), each bank group (20) having a dedicated state control machine (30).

11. The method of claim 10, wherein the nonvolatile memory (10) has a write-to-read latency of at least 4:1.

12. The method of claim 10, wherein a size and number of the bank groups (24) is such that a time to read a single bank (20) in all of the bank groups (24) is at least a majority of as time to write to an individual bank (20) of an individual bank group (24).

13. The method of claim 10, wherein a size and number of the bank groups (24) is such that a time to read a single bank (20) in all of the bank groups (24) is greater than a time to write to an individual bank (20) of an individual bank group

14. The method of claim 10 further comprising:
writing to a first bank (20) of a first one of the bank groups (24) while concurrently reading an individual bank (20) in each of the bank groups (24).

15. An apparatus comprising:
a nonvolatile memory (10) partitioned into bits grouped in the banks (20), the banks (20) organized as bank groups (24), each bank group (24) having a dedicated state control machine (30), wherein the memory (10) has a number of bank groups (24) exceeding the write-to-read latency of the nonvolatile memory (10), wherein the nonvolatile memory (10) has a write-to-read latency of at least 4:1, and wherein a majority of time to write to an individual bank (20) of one of the bank groups (24) is less than a time to read an individual bank (20) from each of the other bank groups (24); and
a memory controller (202) configured to write to the individual bank (20) while concurrently reading or writing the individual bank (20) in each of the other bank groups (24).
